(19) United States
(12) Patent Application Publication
(10) Pub. No.: US 2014/0339148 A1
(43) Pub. Date: Nov. 20, 2014

(54) SILVER-COATED NANOFIBERS FABRICS FOR PATHOGEN REMOVAL FILTRATION

(71) Applicant: Goodrich Corporation, Charlotte, NC (US)

(72) Inventor: Jin Hu, Hudson Village, OH (US)

(73) Assignee: GOODRICH CORPORATION, Charlotte, NC (US)

(21) Appl. No.: 13/896,638

(22) Filed: May 17, 2013

(51) Int. Cl. B01D 71/02; B01D 67/00; C02F 1/50

(52) U.S. Cl. CPC B01D 71/022; C02F 1/505; B01D 67/0076
USPC 210/295; 210/500.25; 210/491; 427/244

(57) ABSTRACT

The invention provides a novel method of preparing a filter media by thermally bonding silver-coated nanofiber fabrics to a dirt-retaining membrane, a chemical-retaining membrane, a pathogen-retaining membrane, or a combination thereof. The invention also relates to the use of silver-coated nanofiber fabric layer as a component of a microorganism-killing membrane in filter media for a liquid or air filtration system. The filter media of the invention offers efficient disinfection effects, maintaining a low pressure drop and a high flow rate when in use. Further, the filter media is adhesive-layer free and contains at least one thermal binding layer made of spunbonded nonwoven polymeric fabrics. The invention also features a water-purification cartridge and a portable water system thereof.

### BACKGROUND

In an aircraft, a potable water system is generally used to supply cabin outlet facilities (e.g., handwash basins in lavatories and sinks in onboard kitchens) with fresh water. Such a potable water system may use water filter media (e.g., pathogen-retaining filter media) combined with biocides-containing nanofiber fabrics to kill pathogens contained in the water or air (see U.S. patent application US 2011/0297609 A1).

However, when the potable water system uses biocides-containing nanofiber fabrics bound via adhesive layers to the filter media for disinfestation, it has been found that the incorporation of the nanofiber fabrics and the adhesive layers, no matter how thin they are, usually causes a significant drop in the water flow rate and also in the water pressure. Thus, there is a need for the development of a new type of filtration system that can be used in a potable water system in the aviation field. It is desired that such a filtration system offers efficient disinfection effects while achieving a low pressure drop and a high flow rate when in use.

### SUMMARY

The invention provides a novel type of filter media that offers efficient disinfection effects, which also achieves a low water pressure drop and a high water flow rate when in use. Specifically, the filter media of the invention includes a microorganism-killing membrane that contains a thermal binding layer and electrospun nanofiber fabrics that are coated with a silver film, wherein the electrospun nanofiber fabrics are thermally bound to the thermal binding layer.

In certain embodiments, the filter media of the invention is adhesive free (i.e., containing no adhesive layers or pastes).

In one embodiment, the electrospun nanofiber fabrics are thermoplastic fabrics, which can be polyurethane fabrics including high temperature polyurethane elastomeric fabrics, cellulose acetates fabrics, or polyamides fabrics, or a combination thereof.

In another embodiment, the thermal binding layer comprises spunbonded nonwoven polymeric fabrics, such as, polyester fabrics, polypropylene fabrics, polyurethane fabrics, polyimide fabrics, and polyurethane fabrics, or a combination thereof. In certain instances, the spunbonded nonwoven polymeric fabrics are polyester fabrics, such as, Reemay® spunbonded straight polyester nonwoven fabrics (e.g., Reemay® 2004 and Reemay® 2250).

In a separate aspect, the invention provides a method of preparing a filter media, comprising a step of thermally binding silver-coated nanofiber fabrics to at least one membrane selected from the group of a dirt-retaining membrane, a chemical-retaining membrane, and a pathogen-retaining membrane, or a combination thereof, wherein said silver-coated nanofiber fabrics are prepared through depositing a silver film onto nanofiber fabrics (e.g., electronspun nanofiber fabrics).

In certain embodiments, pores of the resulting silver-coated nanofiber fabrics are essentially free of blockage by the deposited silver film.

In separate embodiments, the silver film can be deposited onto the nanofiber fabrics through a chemical vapor deposition, a physical vapor deposition, or a sol gel deposition, or a combination thereof. Exemplified chemical vapor deposition includes, but is not limited to, a vacuum vapor deposition, and a combustion chemical vapor deposition.

The invention also provides a novel method for thermally binding silver-coated nanofiber fabrics to a membrane selected from the group of a dirt-retaining membrane, a chemical-retaining membrane, and a pathogen-retaining membrane, or a combination thereof.

Another aspect of the invention provides a water-purification cartridge that contains the filter media of the invention.

The invention also features a portable water system containing the water-purification cartridge the invention.

When in use, the filter media according to the invention offers advantages, such as, maintaining a high water flow rate and a low water pressure drop. The filter media of the invention is also highly efficient in achieving good disinfection effects. Thus, the filter media of the invention can be used as an add-on component to dirt/chemical filter cartridge currently used in aircraft potable water systems to meet requirements of disinfection without slowing down water flow rate and increasing water pressure drop.

### BRIEF DESCRIPTION OF THE DRAWINGS

FIG. 1 shows a process of producing a SN/SR film by depositing a thin silver coating onto a N/R film that contains nanofiber fabrics (“N”) and Reemay® spundbonded nonwoven fabrics (“R”)

FIG. 2 demonstrates a process of making a SN/SR/R/P film by thermally laminating a N/R film on pathogen-retaining media via a separate layer of Reemay® spundbonded nonwoven fabrics; the resulting assemble (“SN/SR/R/P”) is capped from both sides with Reemay® spundbonded nonwoven fabrics for protection.

FIG. 3 demonstrates a process of making a D/R/SN/SR/R/P film by thermally laminating a SN/SR/R/P film onto dirt/chemical-holding filter media via a separate Reemay® 2250 layer; the resulting assemble (“D/R/SN/SR/R/P”) is then capped with additional Reemay® 2250 layers for protection.

FIG. 4 shows a process of producing a SN/SR/R/SR/SN film by thermally binding two SN/SR films together via another Reemay®2250 layer; and the resulting assemble (“SN/SR/R/SR/SN”) is capped with additional Reemay® 2250 layers for protection.

FIG. 5 shows a process of producing a SN/R/P film by depositing a thin silver coating only onto nanofiber fabric side to obtain a SN/R film, followed by thermally laminating the SN/R films via the R layer (i.e., Reemay® 2250 layer) onto pathogen-retaining media; the resulting assemble (“SN/R/P”) is capped with separate Reemay® 2250 layers for protection.

FIG. 6 shows a process of producing a D/R/SN/R/P film by thermally laminating a SN/R film via the R layer (i.e., the Reemay® 2250 layer) onto pathogen-retaining media, and thermally laminating the SN/R film via another Reemay® 2250 layer onto dirt/chemical holding filter media; and the resulting assemble (“D/R/SN/R/P”) is then capped with additional Reemay® 2250 layers for protection.

FIG. 7 shows a process of producing a SN/R/SN film by thermally laminating two SN/R films together via one of the R layers (i.e., the incorporated Reemay® 2250 layers); and the resulting assemble (“SN/R/SN”) is capped with another Reemay® 2250 layer for protection.

FIG. 8 shows a structure having multiple-turn rolls of biocidal fabrics incorporated inward of a dirt/chemical retaining filter cartridge.

FIG. 9 shows a structure having multiple-turn rolls of biocidal fabrics incorporated outward of a dirt/chemical retaining filter cartridge.

### DETAILED DESCRIPTION

Electrospun nanofiber fabrics containing biocide(s) can be bound to pathogen-retaining water filter media (such as, NanoCeram-PAC™) media to kill pathogens it contacts (see US 2011/0297609). However, there is a challenge to bind nanofiber fabrics to filter media without using adhesive pastes or layers. However, when used, adhesive pastes or layers can block nanofiber pores and biocidal sites, or bring in chemical contaminants from the adhesives into water systems.

The invention provides a novel method of preparing a filter media, comprising a step of thermally binding silver-coated nanofiber fabrics to at least one membrane selected from the group of a dirt-retaining membrane, a chemical-retaining membrane, and a pathogen-retaining membrane, or a combination thereof, wherein said silver-coated nanofiber fabrics are prepared through depositing a silver film onto nanofiber fabrics (e.g., electronspun nanofiber fabrics).

In certain embodiments, pores of the resulting silver-coated nanofiber fabrics are essentially free of blockage by the deposited silver film.

In separate embodiments, the silver film can be deposited onto the nanofiber fabrics through a chemical vapor deposition, a physical vapor deposition, or a sol gel deposition, or a combination thereof.

Chemical vapor deposition includes methods, such as, traditional vacuum vapor deposition (CVD) and combustion chemical vapor deposition (CCVD) by nGima company (www.nGimat.com). Physical vapor deposition (PVD) is performed, for example, by magnetron sputtering or electron beam.

In certain embodiments, the chemical vapor deposition used herein is a vacuum vapor deposition or a combustion chemical vapor deposition.

It is contemplated that other biocidal materials can be deposited onto the nanofiber fabrics. The resulting biocidal-coated nanofiber fabrics can replace the silver-coated nanofiber fabrics used herein. The biocidal deposition can be achieved, for example, by a chemical vapor deposition, a physical vapor deposition, or a sol gel deposition, or a combination thereof.

Thickness of the silver coating can be in a nano-range. By coating the nanofibers with a silver film, the use of biocidal nano-particle can be avoided. Accordingly, the invention provides a nano-particles leach-free method.

The utility of the silver coated fabrics as above delineated avoids the use of nanoparticles or biocidal additive chemicals, which require a subsequent leach of nanoparticles or biocidal additive chemicals. Generally, the silver coatings used herein are not soluble. Thus, the possibility of having leach issues in the process is low.

Further, the large surface offered by nanofiber fabrics provides a huge silver coating area. Accordingly, the biocidal fabrics used herein offer significantly enhanced biocidal effects. Further, the combination of silver-coated nanofiber fabrics and pathogen retaining or dirt/chemical retaining filter media offers various functions including, but not limited to, pathogen control, chemical control, and dirt control while maintaining a low pressure drop and a high water flow rate when in use.

In a separate aspect, the invention provides a method of preparing a filter media. The method comprises a step of thermally binding silver-coated nanofiber fabrics to at least one membrane, such as, a dirt-retaining membrane, a chemical-retaining membrane, and a pathogen-retaining membrane, or a combination thereof. The silver-coated nanofiber fabrics used herein are prepared through depositing a silver film onto nanofiber fabrics.

The invention relates to a method for thermally binding silver-coated nanofiber fabrics to a membrane selected from the group of a dirt-retaining membrane, a chemical-retaining membrane, and a pathogen-retaining membrane, or a combination thereof.

The nanofiber fabrics that can be coated by the method of the invention include, for example, electronspun nanofiber fabrics.

Further, the invention relates to the use of electrospun nanofiber fabrics that are coated with a silver film (or other biocidal material), which are either directly thermally bound to pathogen-retaining filter media or via a thermal binding layer onto pathogen-retaining filter media, for providing filter media with enhanced pathogen killing efficacy. Alternatively, the invention provides filter media comprising multiple turns of silver-coated electrospun nanofiber fabrics (or together with a silver-coated thermal binding layer) for providing pathogen killing efficacy. In certain embodiments, the electrospun nanofiber fabrics are very thin fabrics.

Accordingly, the invention provides filter media comprising a microorganism-killing membrane. The microorganism-killing membrane includes a thermal binding layer (also referred to as a thermal binder) and electrospun nanofiber fabrics coated with a silver film. According to the invention, the filter media does not contain an adhesive layer or adhesive pastes. In certain embodiments, the thermal binding layer is also coated with a silver film. In other embodiments, the thermal binding layer is not coated with a silver film.

According to the invention, the electrospun nanofiber fabrics can be thermoplastic fabrics, including, such as, polyurethane fabrics, cellulose acetates fabrics, high temperature polyurethane elastomeric fabrics, and polyamides fabrics, or a combination thereof. In one embodiment, the electrospun nanofiber fabrics are high temperature polyurethane elastomeric fabrics.

The thermal binding layer of the invention can be made of spunbonded nonwoven polymeric fabrics. Various spunbonded nonwoven polymeric fabrics can be used, including, such as, polyester fabrics, polypropylene fabrics, polyurethane fabrics, polyimide fabrics, and polyurethane fabrics, or a combination thereof. Other polymers or combinations thereof that have high Fraizer permeability or high Textest permeability can also be used.

For example, the spunbonded nonwoven polymeric fabrics for use in the thermal binding layer are polyester fabrics. Exemplified spunbonded nonwoven polymeric fabrics that can be used in the invention include, for example, Reemay® spunbonded polyester fabrics.

Reemay® spunbonded polyester is a sheet structure of continuous filament polyester fibers that are randomly arranged, highly dispersed, and bonded at the filament junctions. The chemical and thermal properties of Reemay® are essentially those of polyester fiber. The fibers' spunbonded structure offers a combination of physical properties, such as, high tensile and tear strength, non-raveling edges, excellent dimensional stability, no media migration, good chemical resistance, and controlled arrestance and permeability. Reemay® fabrics are used in various industries as covers (e.g., garden blankets) or support materials.

Reemay® spunbonded polyester fabrics include either straight or crimped polyester fibers which give the fabrics different filtration and other general performance properties. It is believed that crimped fibers offer properties of softness, conformability, and greater porosity, while straight fibers yield stiffness, tighter structure, and finer arrestance.

In certain embodiments of the invention, the Reemay® spunbonded polyester fabrics used herein are straight polyester fabrics. Exemplified Reemay® spunbonded polyester fabrics include, such as, Reemay® spunbonded polyester nonwovens 2004 (or “Reemay® 2004”), and Reemay® spunbonded polyester nonwovens 2250 (or “Reemay® 2250”). These Reemay® fabrics are filtration grade spunbonded polyester fabrics: for Reemay® 2004, thickness 5.0 mil, Frazer 1400 cfm/ft²; for Reemay® 2250, thickness 5.0 mil, Friazer 1080 cfm/ft².

According to the present invention, the filter media may further include pathogen-retaining filter media, dirt holding filter media, or chemical holding filter media, or a combination thereof.

In certain embodiments, the filter media of the invention includes pathogen-retaining medium. The microorganism-killing membrane is thermally bound to the pathogen-retaining medium via the same thermal binding layer or via another thermal binding layer.

In other embodiments of the invention, the filter media includes dirt/chemical holding filter media, and optionally one or more additional thermal binding layers. When pathogen-retaining medium is also included, the microorganism-killing membrane, via the thermal binding layers, is thermally bound to both the pathogen-retaining medium and the dirt/chemical holding filter media via different surfaces.

The invention also envisions the use of filter media containing at least two of the above-discussed microorganism-killing membranes. If the thermal binding layer in each of the microorganism-killing membranes is coated with a silver film, the microorganism-killing membranes are bound to each other through an additional thermal binding layer. Alternatively, the microorganism-killing membranes can be bound to each other through the thermal binding layers contained therein.

As known in the art, adhesives block some pores of media and biocide sites, further causing reduced flow rate and high pressure drops in a filtration system. By using thin Reemay® fabrics as binders in the filter media, the use of chemical adhesives can be eliminated. Further, biocidal nanofiber fabrics can form multiple-layered filter media or be coupled with other filter media membranes, such as, NanoCeram-PAC™, to achieve a high flow rate and low pressure drop when in use. The use of Reemay® fabrics also makes it possible to fabricate the fabrics contained in the filter media.

According to the invention, a microorganism-killing membrane that contains silver-coated fabrics (such as, SN/SR or SN/R) can be rolled up by multiple turns on a screen roll, which is then placed inward of a dirt/chemical holding filter media (or cartridge). Alternatively, the microorganism-killing membrane of the invention can be rolled up and placed outside of the dirt/chemical holding filter media (or cartridge). The specific design of the roll-up forms depends upon the water-flow direction in a specific portable water system.

Further, rolled-up silver-coated fabrics may contain multiple microorganism-killing membranes of the invention. The rolled-up biocide-loaded fabrics can be placed inward of a dirt/chemical holding filter media (or cartridge), or outside of the dirt/chemical holding filter media (or cartridge), depending on the water-flow direction.

The invention further features a water-purification cartridge containing the filter media of the invention.

Also provided is a portable water system containing the water-purification cartridge of the invention. Generally, a portable water system includes components, such as, a water storage tank, a pump, a supply line, a water-purification device (such as, a water-purification cartridge). For a detailed description on portable water systems and functions thereof, please refer to US 2011/0297609.

A variety of configurations according to the invention are presented in the drawings, where nanofiber fabrics are pre-loaded with biocide(s). In these drawings, Reemay® 2250 is provided as an example of spunbonded nonwoven polymeric fabrics that are used for a thermal binding layer (a thermal binder). The invention covers the use of other types of spunbonded nonwoven polymeric fabrics as a thermal binding layer and the use of other types of biocides.

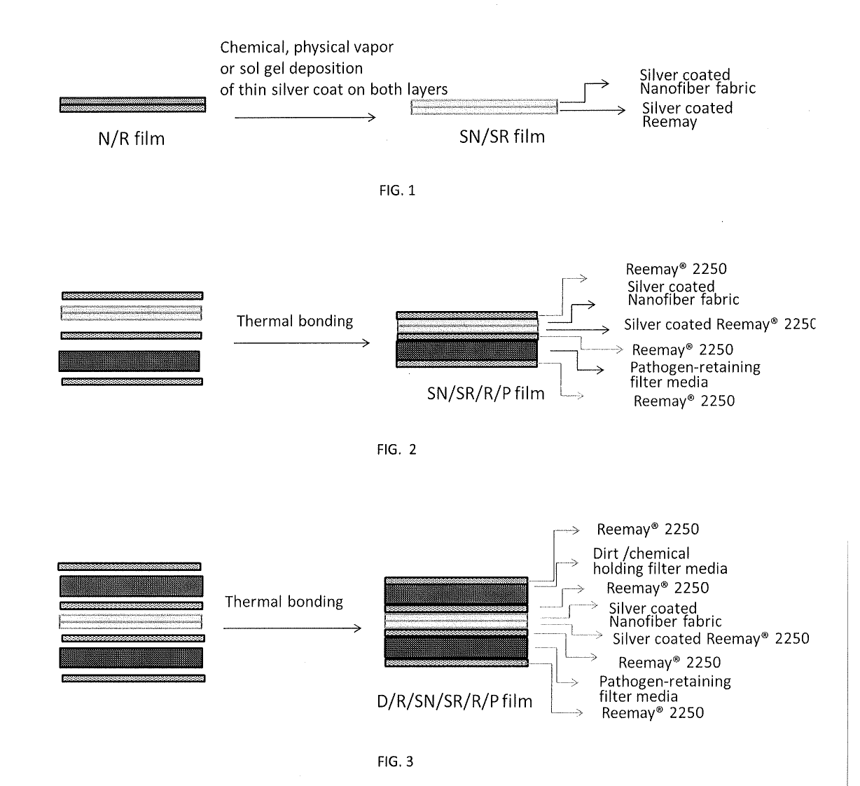

FIG. 1 shows that a N/R film is coated with a thin silver film from both sides via combustion chemical vapor deposition (CCVP). The silver coats the N/R film properly without blocking the pores of fiber fabrics. The resulting silver-coated N/R film is designated as a SN/SR film.

In a CCVD process, silver precursor compounds are added to a burning gas. Flame is moved closely above the surface to be coated. The high energy within the flame converts the precursor compounds into silver particles, which readily interact with the fabric, forming a firmly adhering silver deposit. The resulting micro-/nano-structure and thickness of the deposited silver layer can be controlled by varying process parameters, such as, speed of substrate or flame, number of passes, substrate temperature, and distance between flame and substrate. The N/R film can be obtained by electrospinning nanofiber fabrics onto Reemay® spundbonded nonwoven fabrics.

As known in the art, electrospinning generally uses an electrical charge to draw very fine (typically on the micro or nano scale) fibers from a liquid. Electrospinning shares characteristics of both electrospraying and conventional solution dry spinning of fibers (A. Ziabicki, Fundamentals of fiber formation, John Wiley and Sons, London, 1976, ISBN 0-471-98220-2). The process is non-invasive and does not require the use of coagulation chemistry or high temperatures to produce solid threads from solution. Further, electrospinning from molten precursors has also been practiced in this art, which ensures that no solvent can be carried over into the final product.

A system for performing electrospinning generally includes a spinneret that is connected to a high-voltage direct current power supply, a syringe pump, and a grounded collector. Design of an applicable electrospinning process depends upon many factors, including, such as, molecular weight, molecular-weight distribution and architecture (e.g., branched, linear etc.) of the fibers, solution properties (e.g., viscosity, conductivity, and surface tension), electric potential, flow rate and concentration, distance between the capillary and collection screen, ambient parameters (e.g., temperature, humidity and air velocity in the chamber), and motion of target screen (collector) (see, e.g., http://en.wikipedia.org/wiki/Electrospinning).

Son et al. (Macromol. Rapid Commun. 2004, 25, 1632-1637) provides an electrospinnning method for preparing of antimicrobial fine fibers with silver nanoparticles. The fine fibers with silver nanoparticles were prepared by direct electrospinnning of a cellulose acetate solution containing silver nitrate, followed by photoreduction.

FIG. 2 shows that a SN/SR film is thermally bound onto pathogen-retaining media (such as, NanoCeram® or NanoCeram-PAC™ media) via an additional Reemay® layer. The resulting assemble is designated as a SN/SR/R/P film. The SN/SR layers can readily kill pathogens retained on the pathogen retaining media to prevent biofouling.

As used herein, biofouling (or “biological fouling”) means accumulation of microorganisms on surfaces or pores of the filter media.

FIG. 3 shows that a SN/SR/R/P assemble is thermally laminated with dirt/chemical-holding filter media via Reemay® fabrics. The dirt/chemical filter can be NanoCeram-PAC™ media or other carbon filters. The resulting assemble is designated as a D/R/SN/SR/R/P film. Use of the dirt/chemical-holding filter prevents SN/SR/R/P layers from prematurely losing disinfection properties due to surface blockage by dirt and/or chemicals.

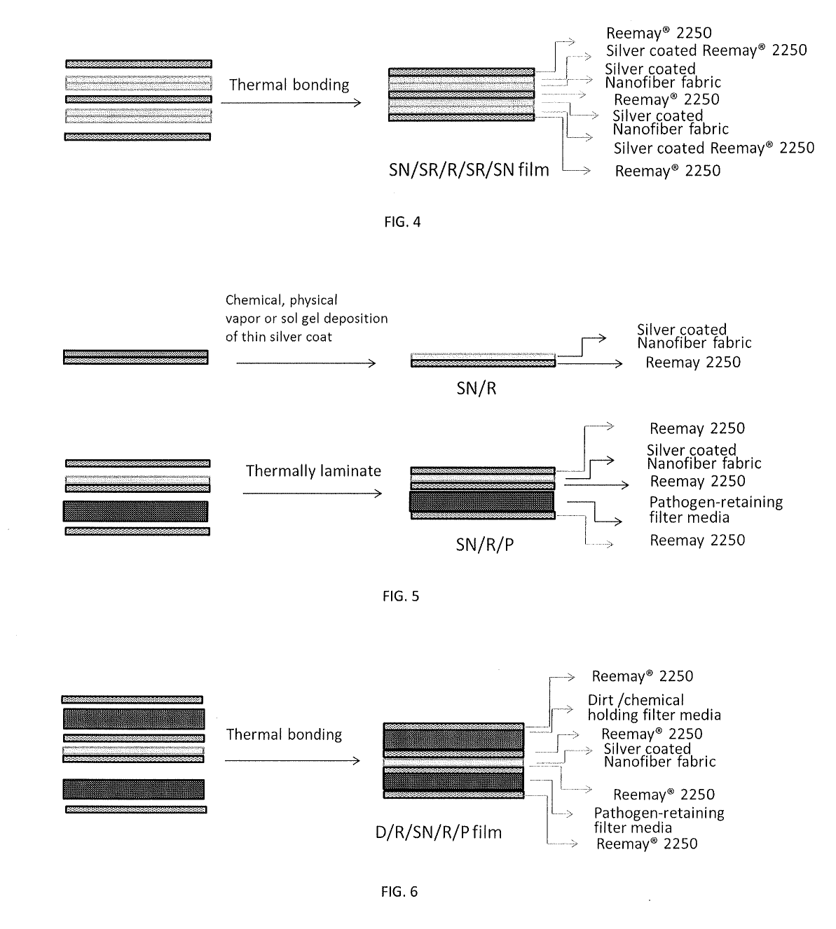

FIG. 4 shows that two SN/SR films are thermally laminated together via Reemay® fabrics. The resulting assemble is designated as a SN/SR/R/SR/SN film. More than two SN/SR films can be thermally laminated if a better disinfection and filtration performance is needed.

FIG. 5 Unlike the process shown in FIG. 1, only the nanofiber fabric side in the N/R film is coated with silver. This is achieved by masking the Reemay® side followed by depositing silver from the nanofiber side. The resulting SN/R film can replace the SN/SR/R film as shown in FIG. 2. Further, the SN/R film can also replace SN/SR/R films shown in the FIGS. 3 and 4.

FIG. 6 shows a process of producing a D/R/SN/R/P film by thermally laminating a SN/R film to pathogen-retaining media via a Reemay® 2250 layer (e.g., the R layer in the SN/R film), and also thermally laminating the SN/R film via another Reemay® 2250 layer to dirt/chemical holding filter media. Further, each side of the resulting assemble (“D/R/SN/R/P”) is capped with two Reemay® 2250 layers for protection.

The two thermal lamination steps can be performed concurrently or sequentially. In one embodiment, the SN/R film is laminated at the same time via Reemay® 2250 layers onto pathogen-retaining media and onto dirt/chemical holding filter media from different sides. In another embodiment, the SN/R film is first laminated via a Reemay® 2250 layer onto pathogen-retaining media, and then onto dirt/chemical holding filter media via another Reemay® 2250 layer. Alternatively, the SN/R film is laminated via a Reemay® 2250 layer onto dirt/chemical holding filter media prior to its lamination to pathogen-retaining media via another Reemay® 2250 layer.

As well understood by an ordinarily skilled artisan, the Reemay® 2250 layer used for laminating a biocidal film can be the Reemay® (“R”) layer (if included in the biocidal film) or a separate Reemay® layer.

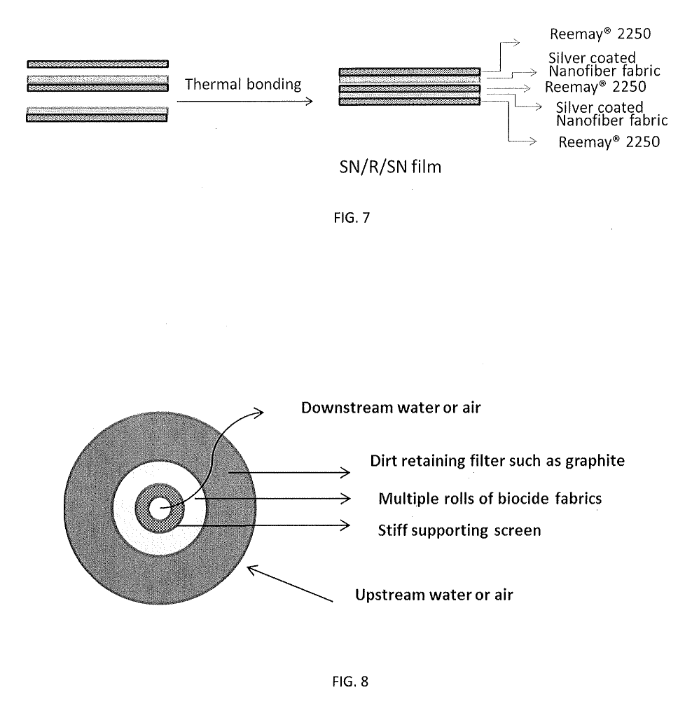

FIG. 7 shows a process of producing a SN/R/SN film by thermally laminating two SN/R films together via one of the Reemay® 2250 layers included in the SN/R films. Further, the resulting assemble is capped with a separate Reemay® 2250 layer for protection.

FIG. 8 shows that biocidal fabrics are rolled on a stiff screen roll multiple turns for providing an enhanced pathogen killing efficiency. The biocidal fabrics that can be used herein include, but are not limited to, a SN/SR film, a SN/R film, a SN/SR/R/SN/SR assemble (shown in FIG. 4), and a SN/R/SN assemble (shown in FIG. 7).

In certain instances, the biocidal fabrics are composed of very thin nanofiber fabrics and/or thin Reemay® fabrics, so that the total thickness of multiple layers of the biocidal fabrics is still thin. The use of such a rolled-up structure does not cause a reduced water flow rate or a significant drop in water pressure. In this drawing, the water flow direction is outward from the center of the filter media ring.

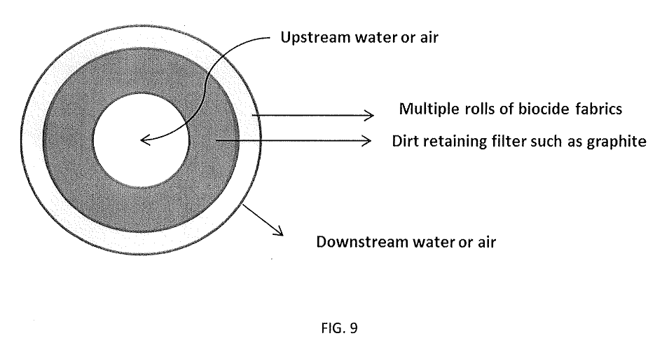

FIG. 9 is similar to FIG. 8. In this case, the biocidal fabrics are rolled on the dirt and chemical retaining filter ring. The water flow direct direction is inward toward center. Likewise, the biocidal fabrics used herein include, for example, a SN/SR film, a SN/R film, a SN/SR/R/SN/SR assemble (shown in FIG. 4), and a SN/R/SN assemble (shown in FIG. 7).

Further, the Reemay® 2250 fabrics can be thermally bound to a membrane or other Reemay® fabrics at a relative low temperature, e.g., 100-130° C. with an appropriate pressure. It is appreciated that at such a low temperature, most fabrics or media will not be thermally damaged.

Also disclosed is a method of coating nanofiber fabrics with a thin biocidal coating. The method includes a step of depositing a biocidal material (e.g., a silver film) onto the nanofiber fabrics, resulting in silver-coated nanofiber fabrics with pores essentially free of bloackage of the deposited silver film.

As above discussed, the use of silver-coated nanofibers fabrics avoids use of nano-silver particles. It eliminates concerns of silver particle leaching and increase disinfection efficiency due to larger silver surfaces.

The invention further relates to the use of silver-coated nanofiber fabrics, which are bound to a thermal binding layer to provide pathogen killing efficacy. By using thin nanofiber fabrics, a high water flow rate and low water pressure drop can be achieved.

Although the application focuses on a water filtration system, it is believed that the filter media of the invention works equally well for an air filtration system or other types of liquid filtration systems.

Accordingly, the invention provides more efficient disinfection filter media for air or liquid filtration, which offers desired properties, such as, a low pressure drop and a high flow rate when in use. Specifically, thin electrospun nonwoven polymeric nanofiber fabrics of the invention are coated with a biocidal material, which is then either directly thermally bound onto pathogen-retaining filter media or via a thermal binder onto pathogen-retaining filter media, provide an enhanced pathogen killing efficacy. Alternatively, filter media containing multiple-rolls of biocidal fabrics also provides good pathogen killing properties.

Still further, the invention relates to a method of preparing filter media for use in a potable water system or an air filtration system. The method comprises thermally binding silver-coated nanofiber fabrics with a thermal binding layer, optionally further with pathogen-retaining media. The thermal binding step can be conducted through a process including, such as, hot calendaring, belt calendaring, through-air thermal bonding, ultrasonic bonding, radiant-heat bonding, hot laminators, vacuum bagging with heat, and autoclave with pressure and heat, or a combination thereof. Specifically, the thermal binding step of the invention is designed to avoid or minimize melting fibers contained in the nanofiber fabrics and/or the thermal binding layer.

For example, the autoclave method can be performed by a process comprising the following steps: 1). Lay up fabrics and membranes; 2). Bag the fabrics and membranes on a support flat metal; 3). Vacuum the bag; 4). Place the assemble in an autoclave; 5). Apply pressure and heat for a period time; 6). Cool the assemble down to an ambient temperature and release vacuum; and 7). Check to ensure that thermal bonding is completed.

### INCORPORATION BY REFERENCE

The entire contents of all patents/patent applications and literature references cited herein are hereby expressly incorporated herein in their entireties by reference.

### EQUIVALENTS

Those skilled in the art will recognize, or be able to ascertain using no more than routine experimentation, numerous equivalents to the specific procedures described herein. Such equivalents are considered to be within the scope of this invention and are covered by the following claims.

I claim:

1. A method of preparing a filter media, comprising a step of thermally binding silver-coated nanofiber fabrics to at least one membrane selected from the group of a dirt-retaining membrane, a chemical-retaining membrane, and a pathogen-retaining membrane, or a combination thereof, wherein said silver-coated nanofiber fabrics are prepared through depositing a silver film onto nanofiber fabrics.

2. The method of claim 1, wherein pores of said silver-coated nanofiber fabrics are essentially free of blockage by the deposited silver film.

3. The method of claim 1, wherein the silver film is deposited through a chemical vapor deposition, a physical vapor deposition, or a sol gel deposition, or a combination thereof.

4. The method of claim 3, wherein said chemical vapor deposition is a vacuum vapor deposition or a combustion chemical vapor deposition.

5. The method of claim 1, wherein the nanofiber fabrics are electronspun nanofiber fabrics.

6. Filter media comprising a microorganism-killing membrane, wherein said microorganism-killing membrane comprises a thermal binding layer and electrospun nanofiber fabrics coated with silver, and said electrospun nanofiber fabrics are thermally bound to the thermal binding layer, and wherein said filter media does not contain an adhesive layer.

7. The filter media of claim 6, wherein the electrospun nanofiber fabrics are thermoplastic fabrics.

8. The filter media of claim 7, wherein the thermoplastic fabrics are selected from the group of polyurethane fabrics, high temperature polyurethane elastomeric fabrics, cellulose acetates fabrics, and polyamides fabrics, or a combination thereof.

9. The filter media of claim 6, wherein the thermal binding layer comprises spunbonded nonwoven polymeric fabrics.

10. The filter media of claim 9, wherein the spunbonded nonwoven polymeric fabrics are selected from the group of polyester fabrics, polypropylene fabrics, polyurethane fabrics, polyimide fabrics, and polyurethane fabrics, or a combination thereof.

11. The filter media of claim 10, wherein the spunbonded nonwoven polymeric fabrics comprise Reemay® straight spunbonded polyester nonwoven fabrics.

12. The filter media of claim 6, wherein said thermal binding layer is coated with silver.

13. The filter media of claim 6, wherein said filter media further comprises at least one more media selected from pathogen-retaining filter media, dirt holding filter media, and chemical holding filter media.

14. The filter media of claim 6, wherein said filter media comprises pathogen-retaining medium, wherein the microorganism-killing membrane is bound to the pathogen-retaining medium via said thermal binding layer or via another thermal binding layer.

15. The filter media of claim 14, wherein said filter media comprises dirt/chemical holding filter media and one or more additional thermal binding layers, and the microorganism-killing membrane, via said additional thermal binding layer(s), is bound to the dirt/chemical holding filter media at a surface different from a surface used for binding with the pathogen-retaining medium.

16. The filter media of claim 6, wherein said filter media comprises at least two of said microorganism-killing membranes, the thermal binding layers in each of said microorganism-killing membranes is coated with the silver film, wherein said two microorganism-killing membranes are bound to each other through another thermal binding layer.

17. The filter media of claim 6, wherein the microorganism-killing membrane is in a multiple-turn rolled-up form, and said filter media further comprises dirt/chemical holding filter media.

18. The filter media of claim 17, wherein the rolled-up microorganism-killing membrane is placed inward of the dirt/chemical holding filter media.

19. The filter media of claim 16, wherein the rolled-up microorganism-killing membrane is outside of the dirt/chemical holding filter media.

20. A water-purification cartridge comprising the filter media of claim 6.
